(19) United States
(12) Patent Application Publication
(10) Pub. No.: US 2003/0093692 A1
(43) Pub. Date: May 15, 2003

(54) Global deployment of host-based intrusion sensors

(76) Inventor: Phillip A. Porras, Cupertino, CA (US)

Correspondence Address: Moser, Patterson & Sheridan, LLP, 595 Shrewbury Avenue, Suite 100, Shrewbury, NJ, 07702, US

(21) Appl. No.: 10/012,104

(22) Filed: Nov. 13, 2001

(51) Int. Cl. G06F 11/30

(52) U.S. Cl. 713/201

(57) ABSTRACT

A method includes, in a server, receiving parameters pertinent to host systems connected to a local area network and deploying a host-based intrusion detection system from the server to each of the host systems based on the received parameters.

### TECHNICAL FIELD

This invention relates to global deployment of host-based intrusion sensors.

### BACKGROUND

Intrusion detection is a type of security management technology for computers and networks. An intrusion detection system (IDS) gathers and analyzes information from areas within a computer or a network to identify possible security breaches, which include both intrusions (attacks from outside the organization) and misuse (attacks from within the organization). Intrusion detection typically uses vulnerability assessment (sometimes referred to as scanning), which is a technology developed to assess the security of a computer system or network. Intrusion detection functions include: monitoring and analyzing user and system activities; analyzing system configurations and vulnerabilities; assessing system and file integrity; recognizing patterns typical of attacks; analyzing abnormal activity patterns; and tracking user policy violations.

Two example types of intrusion detection systems are host-based intrusion detection systems and network-based intrusion detection systems. A host-based intrusion detection system is typically installed within a single host and analyzes host audit trails, system logs and other accounting logs. A network-based intrusion detection system resides in a network and derives its detection data from analysis of network traffic or transactions derived from network traffic.

### SUMMARY

In general, in an aspect, the invention features a method including, in a server, receiving parameters pertinent to host systems connected to a local area network and deploying a host-based intrusion detection system from the server to each of the host systems based on the received parameters.

Embodiments may include one or more of the following. One of the parameters may come from the group including an Internet Protocol (IP) addresses for each of the host systems, administrative account information for each of the host systems, or a preferred target directory for each of the host systems. Deploying may include logging into an administrative account on each of the hosts systems, loading the host-based intrusion detection system into a target directory in each of the host systems, installing the host-based intrusion detection systems in each of the host systems, and starting the host-based intrusion detection system in each of the host systems.

The method may also include configuring the host-based intrusion detection system on each of the host systems from the server. Configuring may include updating configuration files on each of the host systems using S-HTTP on the server. Updating may include interaction through a browser-like interface on the server.

The method may also include monitoring alerts generated by each of the host-based intrusion detection systems in each of the hosts using a viewer installed on the server. The viewer may include an S-HTTP graphical user interface (GUI).

In general, in another aspect, the invention features a system including a network of host systems, a network appliance connected to the network, the network appliance including a graphical user interface (GUI), means for receiving parameters pertinent to host systems, and means for deploying a host-based intrusion detection system to each of the host systems in conjunction with the received parameters.

Embodiments may include one or more of the following. The GUI may be an S-HTTP GUI. The GUI may be a web-like browser. One of the parameters may come from the group including Internet Protocol (IP) addresses for each of the host systems, administrative account information for each of the host systems, and a preferred target directory for each of the host systems.

The means for deploying may include logging into an administrative account on each of the hosts systems, loading the host-based intrusion detection system into a target directory in each of the host systems, installing the host-based intrusion detection systems in each of the host systems, and starting the host-based intrusion detection system in each of the host systems.

The system may also include means for configuring the host-based intrusion detection system on each of the host systems from the server. The means for configuring may include updating configuration files on each of the host systems using S-HTTP on the server through the GUI. Updating may include interaction through a browser-like interface on the server.

The system may also include means monitoring alerts generated by each of the host-based intrusion detection systems in each of the hosts on a viewer installed on the server. The viewer may be an S-HTTP graphical user interface (GUI).

In general, in another aspect, the invention features a method including, in a host system residing on a network, receiving a remote request from a server to log on to administrative account, receiving an installation of a host-based intrusion detection system from the server, and sending alerts from the host-based intrusion system to the server.

Embodiments may include one or more of the following. The installation may include allowing the server to unpack, install and start the host-based intrusion detection system.

The method may also include receiving configuration changes for the host-based intrusion detection system from the server.

The method may also include sending a local copy of a configuration file to the server.

In general, in another aspect, the invention features a method including in a server, receiving parameters pertinent to host systems connected to a local area network and deploying an information sensor from the server to each of the host systems based on the received parameters.

Embodiments may include one or more of the following. One of the parameters may come from the group including an Internet Protocol (IP) address for each of the host systems, administrative account information for each of the host systems, or a preferred target directory for each of the host systems. The information sensor generates intrusion alarms and/or anomaly reports.

The information sensor may generate information pertaining to security of each of the host systems.

Deploying may include logging into each of the host's systems and loading the information sensor into a target directory in each of the host systems. Deploying may also include installing the information sensor and starting the information sensor.

The method may include configuring the information sensor on each of the host systems from the server and configuring may include updating configuration files on each of the host systems using a cryptographically secure communication channel on the server. The cryptographically secure communication channel may be S-HTTP.

Updating may include interaction through a browser-like interface on the server.

The method may also include monitoring alerts generated by each of the information sensors in each of the hosts using a viewer installed on the server. The viewer may include a cryptographically secure communication channel graphical user interface (GUI).

In general, in another aspect, the invention includes a system including a network of host systems, a network appliance connected to the network, the network appliance including a graphical user interface (GUI), means for receiving parameters pertinent to host systems and means for deploying an information sensor system to each of the host systems in conjunction with the received parameters.

Embodiments may include one or more of the following. The GUI may include a cryptographically secure communication channel GUI. And the GUI may be a web-like browser.

The parameters may come from the group Internet Protocol (IP) addresses for each of the host systems, administrative account information for each of the host systems and a preferred target directory for each of the host systems.

The means for deploying may include logging into each of the host's systems, loading the information sensor system into a target directory in each of the host systems, installing the information sensor systems in each of the host systems and starting the information sensor system in each of the host systems.

The system may also include means for configuring the information sensor system on each of the host systems from the server. The means for configuring may include updating configuration files on each of the host systems using a cryptographically secure communication channel on the server through the GUI. Updating may include interaction through a browser-like interface on the server.

The system may also include means monitoring alerts generated by each of the information sensor systems in each of the hosts on a viewer installed on the server. The viewer may be a cryptographically secure communication channel graphical user interface (GUI)

In general, in another aspect, the invention features a method including a host system residing on a network, receiving a remote request from a server to log on and receiving an installation of an information sensor system from the server.

Embodiments may include one or more of the following. The method may also include sending alerts from the host-based intrusion system to the server. The installation may include allowing the server to unpack, install and start the information sensor system.

The method may also include receiving configuration changes for the information sensor system from the server and sending a local copy of a configuration file to the server.

Embodiments of the invention may have one or more of the following advantages.

The deployment, configuration, and management of a suite of host-based intrusion detection systems is achieved by the insertion of a smart network appliance. For example, time required for installation and configuration of two hundred host-based intrusion detection systems is reduced from one hundred hours to twenty minutes or less.

Alert management and configuration are reduced to a simple web page interaction. As a result, host-based intrusion detection becomes economically feasible, and introduces detection and recovery capability over one of the highest threat, highest cost, attacks that face corporate and military network environments.

Automatic installation of host-based intrusion detection systems in a network provides powerful insight into major misuse, insider, policy violation threats. The automatically installed and configured host-based intrusion detection system directly addresses insider attacks and proprietary theft, such as faults, resource exhaustion and malicious destruction. The host-based intrusion detection system is in a position to react and stop malicious activity, generates low false positives, is difficult to circumvent, and is not subject to crypto, bandwidth and network topology.

The observation and deployment network appliance deploys host-based intrusion detection system components to hosts spread over a Local Area Network (LAN) using a minimum amount of information, e.g., a list of host Internet Protocol (IP) addresses and root passwords over each host.

The observation and deployment network appliance may also maintain a database, s-http and secure network interface through which the deployed host intrusion detection systems can report back alarms and health-status messages. The contents of this database are accessible by authorized users via s-http.

A host viewer interface can display updates to the database in real time, and can display the current disposition of all host-based intrusion detection systems installed in the LAN. The same interface can be used to shut down, reconfigure and re-start one or more of the host-based intrusion detection systems.

Other features and advantages of the invention will be apparent from the description and drawings, and from the claims.

### DESCRIPTION OF DRAWINGS

FIG. 1 shows a Local Area Network (LAN).

FIG. 2 shows a host system.

FIG. 3 shows a global observation and HIDS deployment network appliance.

FIG. 4 shows a host-based intrusion detection system deployment, configuration and monitoring process.

### DETAILED DESCRIPTION

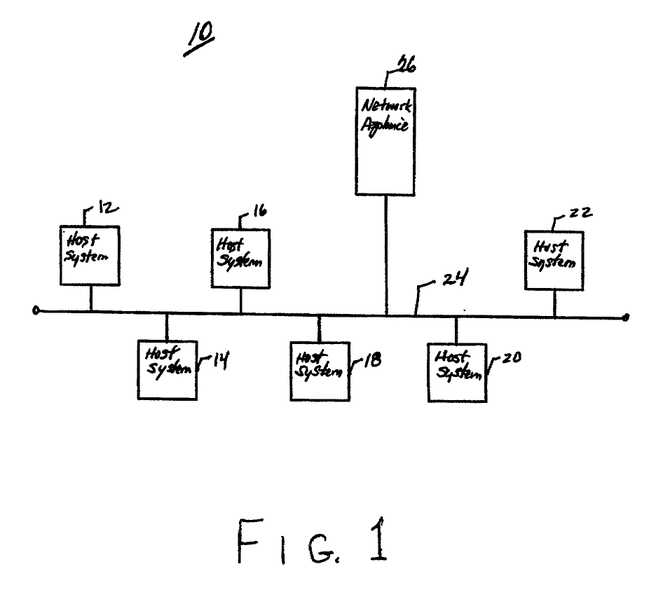

Referring to FIG. 1, a Local Area Network (LAN) 10 includes host systems 12, 14, 16, 18, 20 and 22, respectively, connected to a networking medium 24. The LAN 10 also includes a global observation and deployment network appliance 26 connected to the line 24. The medium 24 may include, for example, Ethernet (specified in IEEE 802.3), Token Ring, ARCNET, and FDDI (Fast Distributed Data Interface). Each of the host systems 12-22 in the LAN 10 communicates through the medium 24 using TCP/IP (Transmission Control Protocol/Internet Protocol) or another suitable protocol.

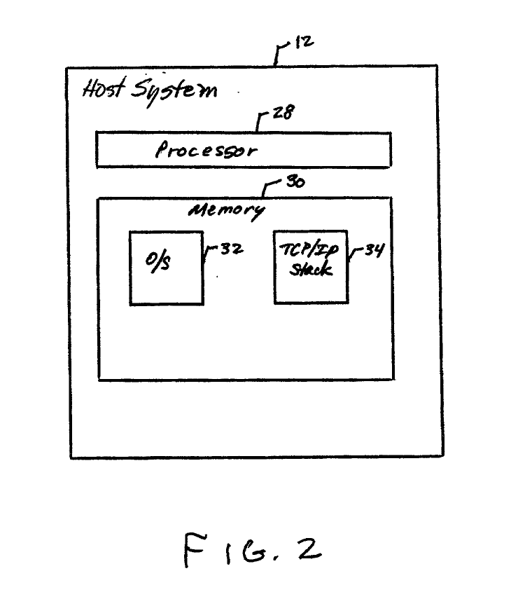

Referring to FIG. 2, each of the host systems, host system 12 for example, contains a processor 28 and a memory 30. Memory 30 stores an operating system (“OS”) 32 and a TCP/IP protocol stack 34 for communicating on the medium 24.

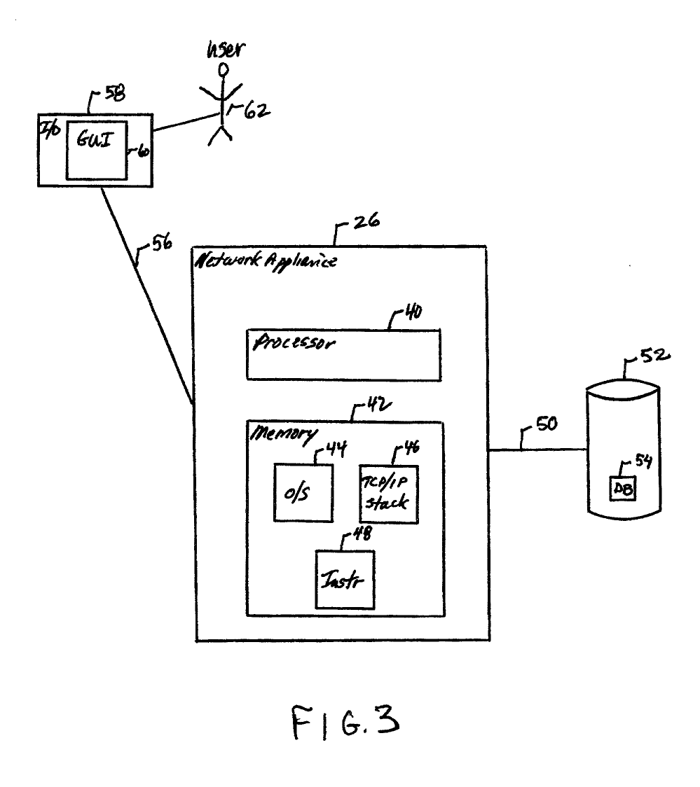

Referring to FIG. 3, the global observation and deployment network appliance 26 contains a processor 40 and a memory 42. Memory 42 stores an operating system (“OS”) 44, a TCP/IP protocol stack 46 for communicating on the medium 24, and machine-executable instructions to perform a host-based intrusion detection system deployment, configuration and monitoring process 48. The network appliance 26 also includes a link 50 to a storage device 52. The storage device 52 houses a database 54 and can be managed using any suitable database management system, such as Oracle from Oracle Corporation of Redwood Shores, Calif. The network appliance 26 also includes a link 56 to an input/output (I/O) device 58 having a graphical user interface (GUI) 60 for display to an administrative user 62. An example GUI 60 is a web browser, such as Netscape Navigator from AOL Corporation or Internet Explorer from Microsoft Corporation.

The network appliance 26 supports S-HTTP. S-HTTP (Secure HTTP) is an extension to the Hypertext Transfer Protocol (HTTP) that allows the secure exchange of files on the World Wide Web (“Web”). Each S-HTTP file is either encrypted, contains a digital certificate, or both. For a given document, S-HTTP is an alternative to another well-known security protocol, Secure Sockets Layer (SSL). A major difference is that S-HTTP allows the client to send a certificate to authenticate the user whereas, using SSL, only the server can be authenticated. S-HTTP is typically used in situations where the server represents, for example, a bank, and requires authentication from the user that is more secure than a user identification and password. S-HTTP does not use any single encryption system, but it does support the Rivest-Shamir-Adleman (“RSA”) public key infrastructure encryption system. SSL works at a program layer slightly higher than the Transmission Control Protocol (TCP) level. S-HTTP works at a higher level of the HTTP application. A browser user can use both security protocols, but only one can be used with a given document.

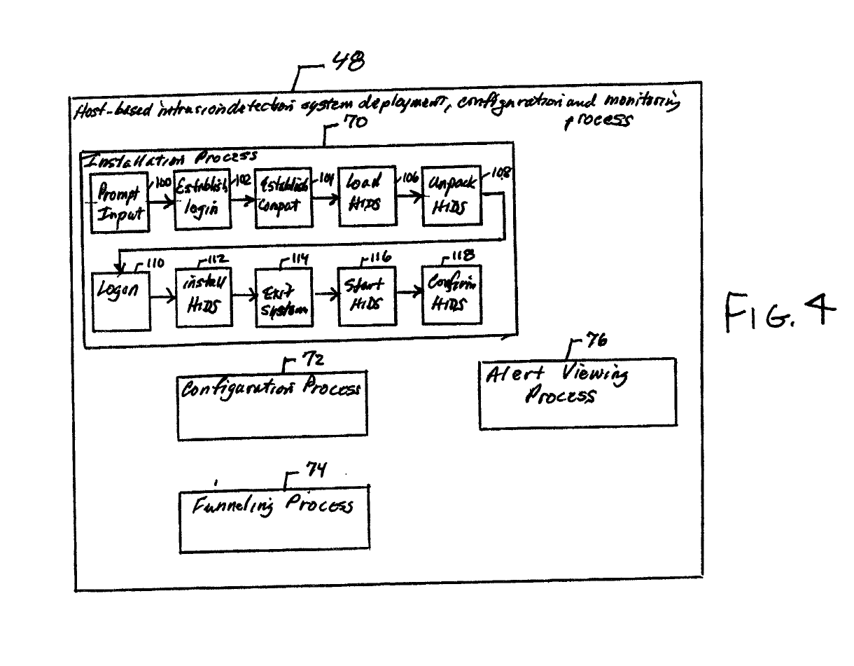

Referring to FIG. 4, the host-based intrusion detection system deployment, configuration and monitoring process 48 includes an installation process 70, a configuration process 72, a funneling process 74, and an alert viewing process 76. The host-based intrusion detection system deployment, configuration and monitoring process 48 assumes that the systems 12-22 in the LAN 10 contain operating systems (and O/S versions) that are compatible with the operating system 44 (and O/S version) executing in the network appliance 26.

The installation process 70 handles installation of a host-based intrusion detection system (“HIDS”) on each target host (i.e., systems 12-22) in the LAN 10. The installation process 70 prompts (100) the administrative user 62 for initial inputs. The administrative user 62, interacting through a web-type browser on the GUI 60, provides the installation process 60 initial inputs pertaining to each of the systems 12-22 on the LAN 10. For example, the administrative user 62 inputs a valid administrative account and password for access to any one of the systems 12-22. The administrative user 62 provides the installation process 60 a list of target hosts to which host-based intrusion detection coverage is desired. Alternatively, the administrative user 62 can simply provide the installation process 60 an indicator to sweep a local subnet address for all host systems on the LAN 10.

After the administrative user 62 enters the inputs, the installation process 70 establishes (102) a login process to a target host system. The login process may be via secure shell, telnet, or r*. Secure Shell (“SSH”), sometimes known as Secure Socket Shell, is a UNIX-based command interface and protocol for securely getting access to a remote computer. It is widely used by network administrators to control Web and other kinds of servers remotely. SSH is a suite of three utilities—slogin, ssh, and scp—that are secure versions of the earlier UNIX utilities, rlogin, rsh, and rcp. SSH commands are encrypted and secure in several ways. Both ends of a client/server connection are authenticated using a digital certificate, and passwords are protected by being encrypted.

SSH uses RSA public key cryptography for both connection and authentication. Encryption algorithms include Blowfish, DES, and IDEA. IDEA is the default. SSH2, a later version, is a proposed set of standards from the Internet Engineering Task Force (IETF).

The installation process 70 establishes (104) the compatibility of the target host system and the network appliance 26. For example, the installation process 70 may look at the O/S, version number, patch level, processor, disk space, or memory of the target host system, or any combination of the foregoing. Once compatibility of the network appliance 26 and target host system is established (104), the installation process 70 loads (106) the HIDS software from the storage device 52 and unpacks (108) the HIDS software into a target file directory of the target host system.

The installation process 70 logs on (110) to the target host system as the administrative user under an administrative account, installs (112) the HIDS software on the target host system, and exits (114) the administrative user account. The installation process 70 starts (116) the HIDS software and confirms (118) that the HIDS software has begun on the target host system.

After confirmation (118), the installation process 70 exits (120) the target host system, ready to proceed to another host system in the LAN 10.

The configuration process 74 works in conjunction with secure S-HTTPD server software in the network appliance 26. HTTPD refers to a Hypertext Transfer Protocol daemon that resides in the S-HTTP server software and waits in attendance for requests to come in. A daemon is a program that is “an attendant power or spirit”; it waits for requests to come in and then forwards them to other processes as appropriate. The configuration process 72 allows the administrative user 62 to customize optional configuration parameters, including surveillance policy, if desired. The configuration process 72 also allows the administrative user 62 to initiate updates to one or more of the host systems 12-22 on the LAN 10. Each HIDS on each of the host systems 12-22 contains configuration files. A copy of these configuration files is stored locally on the storage device 52 of the network appliance 26. Changes to the local configuration file in the storage device 52 of the network appliance 26 can be propagated to their respective host systems 12-22.

The funneling process 74 maintains an established connection with each of the HIDS that are installed on each of the host systems 12-22. The funneling process 74 receives alerts from each of the HIDS and stores the received alerts in the database 54 of the storage device 52.

The alert viewing process 76 allows the administrative user 62 to monitor alerts generated by the HIDS and received by the network appliance 26 as they are received.

Other embodiments are possible. For example, the process 48 may deploy other sorts of information sensors in place of the host-based intrusion detection system. Other information sensors may include any sensor capable of generating intrusion alarms or anomaly reports.

What is claimed is:

1. A method comprising:
in a server, receiving parameters pertinent to host systems connected to a local area network; and
deploying a host-based intrusion detection system from the server to each of the host systems based on the received parameters.

2. The method of claim 1 in which one of the parameters come from the group comprising of an Internet Protocol (IP) addresses for each of the host systems, administrative account information for each of the host systems, or a preferred target directory for each of the host systems.

3. The method of claim 1 in which deploying comprises:
logging into an administrative account on each of the hosts systems;
loading the host-based intrusion detection system into a target directory in each of the host systems;
installing the host-based intrusion detection systems in each of the host systems; and
starting the host-based intrusion detection system in each of the host systems.

4. The method of claim 1 further comprising configuring the host-based intrusion detection system on each of the host systems from the server.

5. The method of claim 4 in which configuring comprises updating configuration files on each of the host systems using S-HTTP on the server.

6. The method of claim 5 in which updating comprises interaction through a browser-like interface on the server.

7. The method of claim 4 further comprising monitoring alerts generated by each of the host-based intrusion detection systems in each of the hosts using a viewer installed on the server.

8. The method of claim 7 in which the viewer comprises an S-HTTP graphical user interface (GUI).

9. A computer program product residing on a computer readable medium having instructions stored thereon which, when executed by the processor, cause the processor to:
in a server, receive parameters pertinent to host systems connected to a local area network; and
deploy a host-based intrusion detection system from the server to each of the host systems in conjunction with the received parameters.

10. The computer program product of claim 9 in which one of the parameters come from the group comprising of:
Internet Protocol (IP) addresses for each of the host systems;
administrative account information for each of the host systems; and
a preferred target directory for each of the host systems.

11. The computer program product of claim 9 in which the instruction to deploy comprises:
logging into an administrative account on each of the hosts systems;
loading the host-based intrusion detection system into a target directory in each of the host systems;
installing the host-based intrusion detection systems in each of the host systems; and
starting the host-based intrusion detection system in each of the host systems.

12. The computer program product of claim 9 further comprising an instruction to configure the host-based intrusion detection system on each of the host systems from the server.

13. The computer program product of claim 12 in which the instruction to configure comprises updating configuration files on each of the host systems using S-HTTP on the server.

14. The computer program product of claim 3 in which updating comprises interaction through a browser-like interface on the server.

15. The computer program product of claim 12 further comprising an instruction to monitor alerts generated by each of the host-based intrusion detection systems in each of the hosts on a viewer installed on the server.

16. The computer program product of claim 7 in which the viewer is an S-HTTP graphical user interface (GUI).

17. A system comprising:
a network of host systems;
a network appliance connected to the network, the network appliance comprising:
a graphical user interface (GUI);
means for receiving parameters pertinent to host systems; and
means for deploying a host-based intrusion detection system to each of the host systems in conjunction with the received parameters.

18. The system of claim 17 in which the GUI is an S-HTTP GUI.

19. The system of claim 17 in which the GUI is a web-like browser.

20. The system of claim 17 in which one of the parameters come from the group comprising of:
Internet Protocol (IP) addresses for each of the host systems;
administrative account information for each of the host systems; and
a preferred target directory for each of the host systems.

21. The system of 17 in which the means for deploying comprises:
logging into an administrative account on each of the hosts systems;
loading the host-based intrusion detection system into a target directory in each of the host systems;
installing the host-based intrusion detection systems in each of the host systems; and
starting the host-based intrusion detection system in each of the host systems.

22. The system of claim 17 further comprising means for configuring the host-based intrusion detection system on each of the host systems from the server.

23. The system of claim 22 in which means for configuring comprises updating configuration files on each of the host systems using S-HTTP on the server through the GUI.

24. The system of claim 23 in which updating comprises interaction through a browser-like interface on the server.

25. The system of claim 22 further comprising means monitoring alerts generated by each of the host-based intrusion detection systems in each of the hosts on a viewer installed on the server.

26. The system of claim 25 in which the viewer is an S-HTTP graphical user interface (GUI).

27. A processor and a memory configured to:
receive parameters pertinent to host systems connected to a local area network in a server; and
deploy a host-based intrusion detection system from the server to each of the host systems in conjunction with the received parameters.

28. A method comprising:
in a host system residing on a network, receiving a remote request from a server to log on to administrative account; and
receiving an installation of a host-based intrusion detection system from the server.

29. The method of claim 28 further comprising sending alerts from the host-based intrusion system to the server.

30. The method of claim 28 in which the installation comprises allowing the server to unpack, install and start the host-based intrusion detection system.

31. The method of claim 28 further comprising receiving configuration changes for the host-based intrusion detection system from the server.

32. The method of claim 31 further comprising sending a local copy of a configuration file to the server.

33. A method comprising:
in a server, receiving parameters pertinent to host systems connected to a local area network; and
deploying an information sensor from the server to each of the host systems based on the received parameters.

34. The method of claim 33 in which one of the parameters comes from the group comprising of an Internet Protocol (IP) address for each of the host systems, administrative account information for each of the host systems, or a preferred target directory for each of the host systems.

35. The method of claim 33 in which the information sensor generates intrusion alarms.

36. The method of claim 33 in which the information sensor generates anomaly reports.

37. The method of claim 33 in which the information sensor generates information pertaining to security of each of the host systems.

38. The method of claim 33 in which deploying comprises:
logging into each of the hosts systems; and
loading the information sensor into a target directory in each of the host systems.

39. The method of claim 38 in which deploying further comprises installing the information sensor.

40. The method of claim 39 in which deploying further comprises starting the information sensor in each of the host systems.

41. The method of claim 33 further comprising configuring the information sensor on each of the host systems from the server.

42. The method of claim 41 in which configuring comprises updating configuration files on each of the host systems using a cryptographically secure communication channel on the server.

43. The method of claim 42 in which the cryptographically secure communication channel is S-HTTP.

44. The method of claim 42 in which updating comprises interaction through a browser-like interface on the server.

45. The method of claim 41 further comprising monitoring alerts generated by each of the information sensors in each of the hosts using a viewer installed on the server.

46. The method of claim 45 in which the viewer comprises a cryptographically secure communication channel graphical user interface (GUI).

47. A computer program product residing on a computer readable medium having instructions stored thereon which, when executed by the processor, cause the processor to:
in a server, receive parameters pertinent to host systems connected to a local area network; and
deploy an information sensor from the server to each of the host systems based on the received parameters.

48. The computer program product of claim 47 in which one of the parameters come from the group comprising of an Internet Protocol (IP) address for each of the host systems, administrative account information for each of the host systems, or a preferred target directory for each of the host systems.

49. The computer program product of claim 47 in which the information sensor generates intrusion alarms.

50. The computer program product of claim 47 in which the information sensor generates anomaly reports.

51. The computer program product of claim 47 in which the information sensor generates information pertaining to security of each of the host systems.

52. The computer program product of claim 47 in which instructions to deploy comprise:
logging into each of the hosts systems; and
loading the information sensor into a target directory in each of the host systems.

53. The computer program product of claim 52 in which instructions to deploy further comprise installing the information sensor.

54. The computer program product of claim 53 in which instructions to deploy further comprise starting the information sensor in each of the host systems.

55. The computer program product of claim 47 further comprising instructions to configure the information sensor on each of the host systems from the server.

56. The computer program product of claim 55 in which instructions to configure include instructions to update configuration files on each of the host systems using a cryptographically secure communication channel on the server.

57. The computer program product of claim 56 in which the cryptographically secure communication channel is S-HTTP.

58. The computer program product of claim 56 in which instructions to update include interaction through a browser-like interface on the server.

59. The computer program product of claim 55 further comprising instructions to monitor alerts generated by each of the information sensors in each of the hosts using a viewer installed on the server.

60. The computer program product of claim 45 in which the viewer comprises a cryptographically secure communication channel graphical user interface (GUI).

61. A system comprising:
a network of host systems;
a network appliance connected to the network, the network appliance comprising:
a graphical user interface (GUI);
means for receiving parameters pertinent to host systems; and
means for deploying an information sensor system to each of the host systems in conjunction with the received parameters.

62. The system of claim 61 in which the GUI is a cryptographically secure communication channel GUI.

63. The system of claim 61 in which the GUI is a web-like browser.

64. The system of claim 61 in which one of the parameters comes from the group comprising of:
Internet Protocol (IP) addresses for each of the host systems;
administrative account information for each of the host systems; and
a preferred target directory for each of the host systems.

65. The system of 61 in which the means for deploying comprises:
logging into each of the host systems;
loading the information sensor system into a target directory in each of the host systems;
installing the information sensor systems in each of the host systems; and
starting the information sensor system in each of the host systems.

66. The system of claim 61 further comprising means for configuring the information sensor system on each of the host systems from the server.

67. The system of claim 66 in which means for configuring comprises updating configuration files on each of the host systems using a cryptographically secure communication channel on the server through the GUI.

68. The system of claim 67 in which updating comprises interaction through a browser-like interface on the server.

69. The system of claim 66 further comprising means monitoring alerts generated by each of the information sensor systems in each of the hosts on a viewer installed on the server.

70. The system of claim 69 in which the viewer is a cryptographically secure communication channel graphical user interface (GUI).

71. A processor and a memory configured to:
receive parameters pertinent to host systems connected to a local area network in a server; and
deploy an information sensor system from the server to each of the host systems in conjunction with the received parameters.

72. A method comprising:
in a host system residing on a network, receiving a remote request from a server to log on; and
receiving an installation of an information sensor system from the server.

73. The method of claim 72 further comprising sending alerts from the host-based intrusion system to the server.

74. The method of claim 72 in which the installation comprises allowing the server to unpack, install and start the information sensor system.

75. The method of claim 72 further comprising receiving configuration changes for the information sensor system from the server.

76. The method of claim 75 further comprising sending a local copy of a configuration file to the server.
